(19) United States
(12) Patent Application Publication
(10) Pub. No.: US 2013/0260000 A1
(43) Pub. Date: Oct. 3, 2013

(54) CONCENTRATED FLAVOUR BASE PRODUCT

(71) Applicants: Rebecca Lian Hwee Peng, Beijing (CN); Lan Qin, Shanghai (CN); Helge Ulmer, Singapore (SG)

(72) Inventors: Rebecca Lian Hwee Peng, Beijing (CN); Lan Qin, Shanghai (CN); Helge Ulmer, Singapore (SG)

(21) Appl. No.: 13/994,014

(22) PCT Filed: Dec. 12, 2011
(86) PCT No.: PCT/EP11/72462

§ 371 Date: Jun. 13, 2013

(30) Foreign Application Priority Data
Dec. 13, 2010 (CN) 201010613489.1

(51) Int. Cl. A23L 1/226

(52) U.S. Cl. CPC A23L 1/22607
USPC 426/533

(57) ABSTRACT

A concentrated flavour base product, prepared by carrying out a thermal reaction between a tonality delivering ingredient and at least one thermal reaction precursor, and a method for preparing a culinary flavouring product from ingredients including a tonality delivering ingredient and other ingredients, comprising reacting the tonality delivering ingredient with at least one thermal reaction precursor to obtain an intermediate product and processing the intermediate product with the other ingredients to obtain the final culinary flavouring product.

### TECHNICAL FIELD

The invention relates to a concentrated flavour base product and a method for producing such a product. The product contains volatile and/or non-volatile flavouring compounds in high concentrations. The product can be used in cooking or can be processed further to a culinary flavouring product.

### BACKGROUND

Most food products develop their flavour during cooking. Raw meat, for example, has a salty, bloody taste with very little flavour. A palatable meaty flavour is formed only during cooking. Reactions such as Maillard reactions, lipid oxidation, hydrolysis and other interactions that occur during cooking produce characteristic cooked flavours. However, flavours generated in such a way typically do not have enough strength to be used as flavourings for other food preparations. These drawbacks can be overcome by using a culinary flavouring product. These flavouring products are concentrated products prepared using thermal reactions, which result in a strong flavour. During cooking of food, the flavouring product is added to the food to give a better or stronger flavour and may be used to satisfy different consumer tastes.

U.S. Ser. No. 11/584,099 describes a flavour composition formed by combining first a precursor composition with a second precursor composition to form a precursor flavour composition. The precursor flavour composition is then subjected to a temperature sufficient to cause one or both of the first and second precursor compositions to undergo at least a partial phase change to a gaseous material. Generally, the first and second precursor compositions are immiscible. The first precursor composition comprises vegetable oil, animal fats, dairy fats, lipolyzed fats, oil soluble materials, and combinations thereof. The second precursor composition is comprised of amino acids, reducing sugars, and combinations thereof. The first and second precursor compositions further include soy sauce, salt, pepper, yeast extract, food extracts, and combinations thereof. The reactions between the first precursor composition and the second precursor composition include Maillard reactions. Maillard reactions have an important role in the production of flavouring products. In the invention described, all components are mixed to produce a flavouring product, which reduces the concentration of reactants. Thus, the formation of the flavouring product does not proceed efficiently, resulting in a low yield of odorants and tastants etc. in the flavouring product. Therefore, the strength of flavour is likely to be low.

CA 2,308,929 relates to a method for producing a bouillon substance. A bouillon precursor particulate mixture is formed comprising a salt, an effervescing agent (e.g., baking soda), a flavouring agent, and a bulking agent comprising maltodextrin. An anti-caking agent is preferably added to the mixture and the hydrated blend is formed into shaped substances. The bouillon substance has a moisture content of between about 1.4% and 2.2% wet weight basis, a hardness of at least about 6.5 kg, and a dissolution time in 93° C. water of less than about one minute. The invention only relates to the dilution of the flavouring product, not the preparation of the flavouring product.

U.S. Pat. No. 6,358,549 concerns a precursor mixture of flavourings and a food composition containing the precursor mixture of flavourings. The precursor mixture includes at least one polysulfide and at least one non-volatile source of sulfur having at least one sulfhydryl group. The precursor mixture generates an aromatic note due to the formation of thiols when heated to provide a roasted or grilled flavour to a food composition. The invention relates only to one roasted or grilled flavour, not any other flavouring products.

In the above examples of flavourings, either all components are mixed to produce a flavouring product (resulting in a low flavour intensity) or the flavouring product has a simple flavour (which does not satisfy the need for flavouring products that strong and complex flavour profiles).

It is therefore an object of the invention to provide a concentrated flavour base product that overcomes, at least in part, some or all of the disadvantages of known flavour products.

### SUMMARY OF THE INVENTION

In a first aspect of the invention there is provided a concentrated flavour base product, prepared by carrying out a thermal reaction between a tonality delivering ingredient and at least one thermal reaction precursor.

The amount of thermal reaction precursor is preferably from 5 to 500 parts by weight based on 100 parts by weight of the tonality delivering ingredient.

The tonality delivering ingredient is preferably selected from edible meat, aromatic plants, vegetables, or a combination thereof.

Preferably, the thermal reaction precursor comprises a carbonyl-containing compound, an amino-containing compound, or a combination thereof.

In preferred embodiments of the invention, the thermal reaction is a Maillard reaction. The thermal reaction may be carried out under any suitable conditions, preferably at 50 to 180° C. for 10 to 360 min.

In a second aspect of the invention there is provided a method for producing a concentrated flavour base product, which comprises thermally reacting a tonality delivering ingredient with at least one thermal reaction precursor.

The method may further comprise milling the tonality delivering ingredient into a paste or a powder before the thermal reaction step. Preferably, the milling is colloid milling.

In a further aspect of the invention there is provided a method for preparing a culinary flavouring product from ingredients including a tonality delivering ingredient and other ingredients, comprising the steps of:
a) reacting the tonality delivering ingredient with at least one thermal reaction precursor to obtain an intermediate product;
b) processing the intermediate product of step a) with the other ingredients to obtain the final culinary flavouring product.

Step b) may be granulation, drying, pasteurisation, or a combination thereof.

The other ingredients may be selected from starch, MSG, salt, and water, or a combination thereof.

Preferably, the method includes milling the tonality delivering ingredient into paste or powder before step a).

In another aspect of the invention there is provided a culinary flavouring product prepared by the method of the invention, which product may be in the form of liquid, paste, powder or granules.

### BRIEF DESCRIPTION OF DRAWINGS

FIG. 1 is a spider web of sensory profiling results for Example 1 and Comparative Example 1.

FIG. 2 shows electronic nose results for Example 1 and Comparative Example 1.

FIG. 3 is a spider web of sensory profiling results for Example 2 and Comparative Example 2.

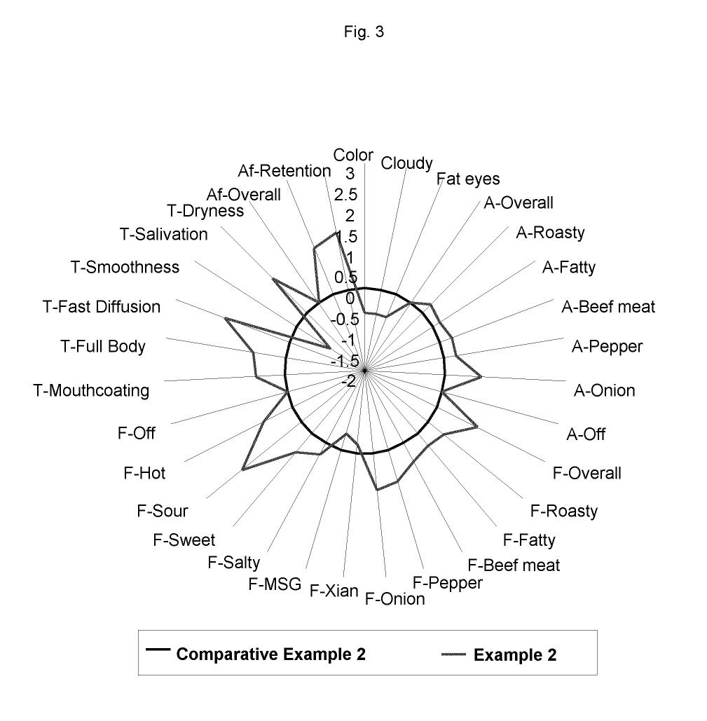

### DETAILED DESCRIPTION

In order to overcome the problems above, the prior thermal reactions between the tonality delivering ingredients and precursors are controlled. Thus not only the problem of strength of the flavour is solved, but also the complex (combined) flavour of flavouring products is well presented.

An aspect of the present invention is to provide a concentrated flavour base product and a method for producing the product. The product contains volatile and non-volatile flavouring compounds in high concentration, which can be used in cooking or can be further processed to a culinary flavouring product.

The concentrated base product is prepared by reacting tonality delivering ingredients with thermal reaction precursors. The invention also provides a method for producing a concentrated base product, which comprises at least a step of thermally reacting a tonality delivering ingredient with a thermal reaction precursor.

In the context of this invention, the term “tonality delivering ingredient” refers to a food material that possesses an aroma or flavour characteristic. The specific aroma or flavour of the food material is released under certain conditions (for example heating). Thus, edible materials fall within the range of the tonality delivering ingredients of the invention. For example, the tonality delivering ingredient may be selected from edible meat, aromatic plants or herbs, vegetables, or a combination thereof.

In the field of flavouring products, thermal reactions play an important role. They alter important food attributes such as flavour, colour, nutrition value, antioxidant properties, etc. Heating of raw materials is usually a necessary step to enable thermal reactions to occur.

According to the invention, the thermal reaction includes the classic Maillard reaction between amino-containing compounds and carbonyl-containing compounds. If proteins and carbohydrates coexist in the raw material of a thermal reaction, a series of complex chemical reactions occur between the amino groups of proteins and hydroxyl and carbonyl groups of carbohydrates by auto-catalysis. The process is non-enzymatic browning or Maillard reaction. This type of reaction is used extensively by the food and flavour industry to generate flavours during processing (in-process flavour generation) and to produce process/reaction flavours.

In the present invention, the term “thermal reaction precursor” refers to a reactant in thermal reactions, especially a reactant in Maillard reactions, which comprises carbonyl-containing compounds, amino-containing compounds, or combinations thereof.

According to the present invention, the amount of thermal reaction precursor is from 5 to 500 parts by weight, preferably from 5 to 400 parts by weight, more preferably than 8 to 100 parts by weight, based on 100 parts by weight of the tonality delivering ingredient. The amounts of ingredients may be adjusted to give the best tonality ingredient.

In the thermal reaction, the raw materials are heated to 50 to 180° C. for 10 to 360 min. The raw materials are preferably pre-treated beforehand. This allows each component to be evenly mixed and to react completely. For example, the tonality delivering ingredients and/or thermal reaction precursors are ground into a paste or a powder. The grinding can be milling, preferably colloidal milling, which maintains the original liquid substances within the tonality delivering ingredients.

Another aspect of the present invention is to provide a culinary flavouring product made from the concentrated flavouring base product, and a method for producing the flavouring product.

In traditional processes for producing flavouring products, all ingredients are mixed and the optimal reaction conditions applied to produce the flavouring products. The product characteristics have two aspects: one is whether the full body flavour is natural or reaches the expected result of combined flavours (qualitative), and the second is whether the strength or yield of flavour reaches the expected value (quantitative). However, the optimisation of reaction conditions is a problem. The characteristics of the products (qualitative and quantitative) depend on the reaction/process conditions, such as temperature, duration etc. It is very difficult to obtain superior products in both quantitative and quantitative aspects. The inventors have now found that the qualitative characteristics mainly depend on the reactants for the thermal reaction (tonality delivering ingredients and thermal reaction precursors). If only these substances react, the conditions of reaction can be easily controlled to get better qualitative characteristics. Further, a final flavouring product with high intensity can be obtained by further processing of the intermediates (concentrated product) and other non-reactant ingredients from the thermal reaction.

According to the invention, the method for preparing a culinary flavouring product from ingredients including a tonality delivering ingredient and other ingredients, comprises the steps: a) reacting the tonality delivering ingredient with a thermal reaction precursor to obtain an intermediate product; and b) processing the intermediate product of step a) with the other ingredients to obtain the final culinary flavouring product.

The tonality delivering ingredient and thermal reaction precursors are defined as above. The tonality delivering ingredient is selected from edible meat, aromatic plants, vegetables, and any combination thereof. The thermal reaction precursor comprises carbonyl-containing compounds, amino-containing compounds, or a combination thereof.

In step a) of the above method, the amount of precursor for thermal reaction is from 5 to 500 parts by weight, preferably from 5 to 400 parts by weight, more preferably from 8 to 100 parts by weight, based on 100 parts by weight of the main tonality delivering ingredient.

The thermal reaction can be a Maillard reaction. The thermal reaction is carried out at 50 to 180° C. for 10 to 360 minutes.

According to the invention, the method further comprises the step of pre-treating raw material before step a) to enable complete reaction of the reactants in the thermal reaction. The pre-treatment may comprises any kind of grinding including milling, preferably collide milling.

In step b) of the above method, processing refers to selecting appropriate other ingredients and processing them to give the final flavouring product depending on the specific cooking application. This processing may comprise conventionally used techniques, such as mixing, heating, freezing, granulation, drying, pasteurisation, or a combination thereof.

The other ingredients of step b) are those ingredients other than the above defined tonality delivering ingredient and thermal reaction precursors. The other ingredients are typically selected from starch, MSG, salt, water, or a combination thereof.

The culinary flavouring product of the invention can be in the form of a liquid, paste, powder, granules or other common forms of food.

Preferred embodiments of the invention are described further as follows.

The tonality delivering ingredient is selected from edible meat of any kind, aromatic plants and herbs, vegetables, and any combination thereof. The selection of tonality delivering ingredient depends on target flavour. For example, if the flavour of beef is expected, beef is chosen. If a caraway flavour is expected, caraway is chosen. If the combined flavour of beef and caraway is expected, the two food materials are chosen together.

The flavour is released when raw meat is steamed or roasted. During cooking, each component in the meat undergoes complex changes, and volatile flavour compounds are released. Currently more than 1000 kinds of volatile compounds from meat have been characterised including lactones, pyrazines, furans and sulfides. Studies show that the precursor substances forming these flavours are mainly soluble sugars, compounds containing amino acids and lipids including phospholipids and glycerol triesters. The meat used in the invention can be meat from any kind of livestock, poultry or fish etc.

Aromatic plant and herbs are used to denote those plants having specialised tissues that contain aromatic components possessing strong flavour and aroma. The specialised tissues can be stems, leaves, roots and fruits of the plants. Such aromatic plants/herbs are characterised by oil sacs or glands which contain the flavour and aroma values of the plant, or they contain vacuoles filled with enzymes, which in case of rupture of the plant cells transform precursors into flavour and aroma compounds characteristic of the freshly cut plants. Additionally, aromatic plants/herbs and vegetables contain compounds, such as amino acids of plant, sugars etc. Aromatic herbs include celery, mushrooms, coriander, basil, parsley, ginger, garlic, chives, carrots, cabbage, cauliflower, asparagus, pumpkin, corn, leeks, red chard, tomato etc. Aromatic plants include fruit such as mango, orange, pawpaw, banana, tangerine, lemon, lime, pineapple, apple, pear, etc.

The thermal reaction precursors of the invention comprise carbonyl-containing compounds, amino-containing compounds, or combinations thereof.

The amino-containing compounds may be selected from the group consisting of amino acids, amines, sources of amino acids such as peptides, proteins, their hydrolysates or extracts, hydrolysed vegetable protein, yeast extracts, yeast hydrolysates, soy sauces and mixtures thereof.

Amino acids may be selected from the group consisting of cysteine, cystine, methionine, proline, ornithine, arginine, valine, leucine, isoleucine, phenylalanine, lysine, glycine, glutamic acid and threonine. The most preferred amino acids are cysteine, cystine, methionine, proline, leucine, phenylalanine and glutamic acid. The proteins may be selected from the group consisting of soy proteins, sodium caseinate, whey protein and wheat gluten.

The carbonyl-containing compounds may be selected from the group consisting of mono- and disaccharides, sugar derivatives such as uronic acids, sources of sugar and/or sugar derivatives and their hydrolysates, such as dextrins, glucose syrup, fructose syrup, xylose syrup, hydrolysed pectins and Maillard reaction intermediates bearing at least one carbonyl group such as aldehydes, ketones, alpha-hydroxycarbonyl or dicarbonyl compounds. Preferred carbonyl sources include pentoses (xylose, arabinose and ribose), hexoses (glucose, fructose, mannose, galactose), 6-deoxyhexoses (rhamnose, fucose), disaccharides (lactose and maltose), uronic acids (galacturonic acid), glucose syrup, fructose syrup and hydrolysed pectine. The most preferred carbonyl compounds are xylose, glucose, fructose, rhamnose and lactose.

The above thermal reaction precursors may be combined in any way.

According to the method for producing the concentrated flavouring base product of the invention, the amount of thermal reaction precursor is from 5 to 500 parts by weight, preferably from 5 to 400 parts by weight, more preferably from 8 to 100 parts by weight, based on 100 parts by weight of the tonality delivering ingredient.

In order to mix the tonality delivering ingredients and thermal reaction precursors sufficiently, and make them react completely in the subsequent heating process, the tonality delivering ingredients can be pre-treated by milling or grinding into a paste or a powder before the thermal reaction.

Fresh aromatic plants are preferably kept cool prior to processing to prevent enzymatic degradation. Prior to milling the aromatic plant, the plant may be washed and surface disinfected to remove dirt, debris and other organic matter which may increase the microbial content of the plant. Such washing may comprise spraying the plants with or immersing them in water, a water-detergent, or water-wetting agent mixture. If detergent or another wetting agent is used, the plants should be rinsed to remove residual detergent/wetting agent. Excess water from the washing step should also be removed. The surface disinfection may also be carried out independently after washing step. Techniques for surface disinfection of plants should be capable of keeping the plant intact.

Additionally, plants may be pretreated by separating the leaves from the stems, depending on the specific plant treated. The fresh plant may be further sliced to small pieces prior to milling. This separating and/or slicing process may be accomplished by any acceptable manner known to those skilled in the art. For example, gentle strip-cutting of the whole fresh plant into pieces may be carried out using a cutter.

Fresh meat may be washed and sliced using conventional methods.

The washed and sliced fresh aromatic plant and fresh meat are then subjected to the milling step. Any acceptable milling/grinding method known in the food industry can be used for milling. Since the plants are fresh and contain substantial moisture, it is preferred to use wet milling or colloid milling. A colloid mill can reduce the particle size of a solid in suspension in a liquid by applying hydraulic shear to the processed liquid. Excessive milling time and/or shearing should be avoided to limit aromatic plant cell rupture.

The thermal reactions may be carried out either in an aqueous, a lipid, or a structured lipid phase environment. The tonality delivering ingredient may contain a large amount of water, and different kinds of tonality delivering ingredients comprise different amounts of water. Because of this there is no particular limitation to the addition of water. In the case of an aqueous reaction, the amount of water is between 5 and 99% by weight, more preferably between 60 and 90%. In the case of a lipid environment, the lipid may be derived from a plant or animal and is an edible or comestible lipid, for example soy oil, sunflower oil, palm oil, cotton seed oil, rapeseed oil, coconut oil, corn oil, canola oil, olive oil, beef tallow, lamb tallow, lard, poultry fat, chicken fat, or any combination thereof.

For different kinds of tonality delivering ingredients and corresponding thermal reaction precursors, different temperatures and reaction times may be used. However, the reaction temperature is usually from 50 to 180° C., preferably from 80 to 150° C., more preferably from 90 to 130° C. The temperature of the reaction should be at least 50° C., otherwise the reaction rate is too low. The temperature of reaction should not be more than 180° C., otherwise undesirable burned tastes or scorched flavours may be produced. The duration of the reaction should be more than 10 mins, preferably more than 30 mins, but not more than 6 hrs, preferably within 2 hrs. Otherwise, again an undesirable burned taste or scorched flavour may be produced.

Additionally, the reactant mixtures may further comprise one or more catalysts to enhance the rate of thermal reaction or Maillard reaction. For example, the catalyst may be a compound comprising a phosphate or a carboxylate group, such as disodium hydrogen phosphate or citric acid. It is also possible to add to the reaction mixtures a compound for adjusting the pH. This compound is, for example, a buffer, such as a phosphate buffer, or sodium hydroxide.

Conventionally used reaction apparatus may be used. The apparatus can be closed or open. Preferably, the reaction temperature is achieved by the maximum rate of heating and kept at this point.

The concentrated intermediate product of step a) may be processed or treated according to what final flavouring product is expected. Other ingredients may be added, such as starch, MSG, salt, sugar, colouring, oil, hydrocolloid, or water. For example, if a sauce is expected, water may be added for mixing and dilution. If a flavouring powder is expected, salt and starch may be added, followed by drying and grinding. If a soup is expected, a granulation process may be employed.

Conventional drying techniques include air drying, air convection drying, fluidised bed drying, vacuum drying, freeze drying, solar drying and the like. The drying conditions must be sufficient to reduce the water content in the finished product. It has been found that at a water content of about 5% or less, amorphous films are formed. Excessive drying below about 0.5% may be detrimental to flavour and cause texture degradation. The drying temperature may be varied within standard ranges. For example, if the drying temperature is relatively high, the drying time should be relatively short so that the temperature inside the granule will not reach a point where enzymes are inactivated.

The granulation step may be sifting, high shear granulation, fluidized bed granulation, extrusion-spheronization granulation, spray drying granulation, tablet compression, or roller compaction. As for soup or gravy, the granulation process generates granules having a length or diameter of between 0.5 to 5 mm. Granules having too large or too small particles may cause dissolution and transportation or storage problems.

Although the process can be carried out in batch form, it is preferred that the process be substantially continuous so that, as is customary in production facilities, the speed of the throughput conveyors will be set to accommodate the step in the process that requires the greatest dwell time. In handling of freshly harvested plants, it will be appreciated by those skilled in the art that for different plants, different specific treatment parameters may be required for the steps of the process.

### EXAMPLES

The invention is further described with reference to the following examples. It will be appreciated that the invention as claimed is not intended to be limited in any way by these examples.

### Evaluation Methods

Differences between samples and their corresponding comparative samples were determined by sensory profiling. During the analysis, a group of 9-12 trained panels scored the differences between one sample against its comparative sample in terms of each sensory attribute. Sensory attributes can be roughly categorized into 5 groups: Appearance (A), Odour (O), Flavour (F), Texture (T), Aftertaste (Af). Attributes will be chosen according to the type of sample and scored on a scale of −2 to 3. For example, F-Meaty is important for pork flavoured products, but may not important for juices or candies. A score of −2 for attribute ‘Salty’ means the sample is much less salty compared to the control sample. A score of 1 for attribute ‘T_Mouth coating’ indicates that the sample is more mouth coating than the control, but not to a great extent. Scores were averaged and processed into a spider web diagram to illustrate the differences between samples and controls.

The similarity of volatile compounds between samples and their corresponding comparative samples vs. references were determined by electronic nose analysis. The volatile profile of home-made chicken soup was used as a target reference. When the distance of PC1 of the sample is near to the target reference, the volatile profile of the sample is similar to that of the target reference.

### Example 1

### Chicken Bouillon Reacted Base

Raw chicken was minced, followed by colloid milling and then the milled chicken paste was collected. To 20 kg milled chicken paste was added 4 kg salt, 10 kg sugar and 1 kg xylose and the subsequent mixture subjected to a thermal reaction by heating at 60° C. for 80 minutes. A concentrated base/intermediate product was obtained. 28 kg water, 10 kg sugar and 1 kg modified starch were added to this concentrated chicken flavour base, and the mixture was pasteurised by heating at 82° C. for 10 min. The final product is a chicken bouillon reacted base.

### Comparative Example 1

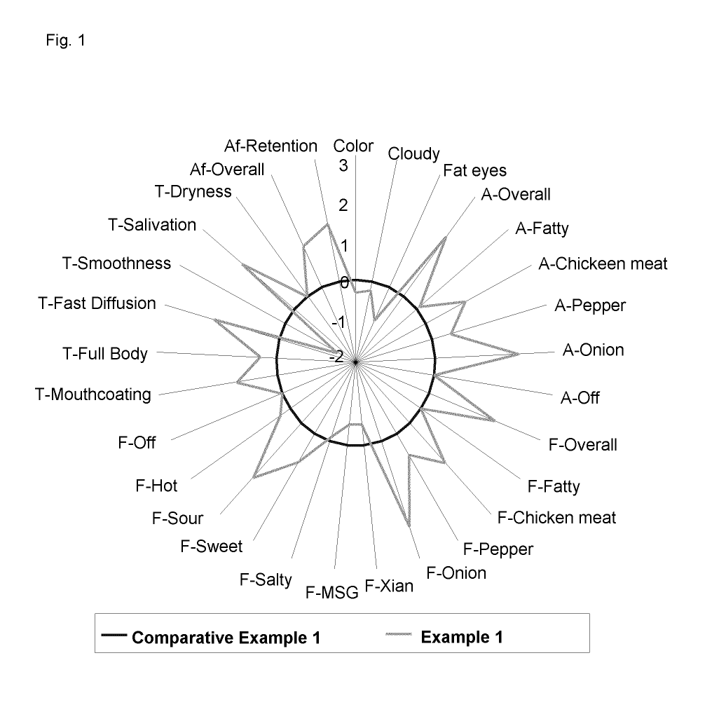

Chicken paste, salt, xylose, modified starch, sugar and water were mixed in the same ratios as for Example 1. The subsequent mixture was pasteurised at 82° C. for 10 min to produce a chicken bouillon reacted base. The product of Example 1 had a significantly enhanced flavour compared to the chicken bouillon reacted base manufactured in the conventional manner described in Comparative Example 1. This can be seen from FIG. 1.

### Example 2

### Beef Flavour Seasoning

Raw beef was minced and colloid milled. 1 kg salt, 0.8 kg dextrose, 3 kg fresh carrot puree, 0.5 kg fresh garlic puree and 3 kg fresh onion puree was added to 3.5 kg milled beef paste and the mixture subjected to a thermal reaction by heating at 80° C. for 90 minutes. A concentrated base/intermediate product was obtained. 70 kg MSG and 51 kg salt was added to the concentrated beef base and the mixture milled for 0.5 min under 5° C. to obtain a paste. The mixture was then granulated to a granule size of 2 mm, and fluidized bed dried for 0.5 min using hot air at 105° C. The beef flavoured seasoning granulated product had a moisture content of 2.5%.

### Comparative Example 2

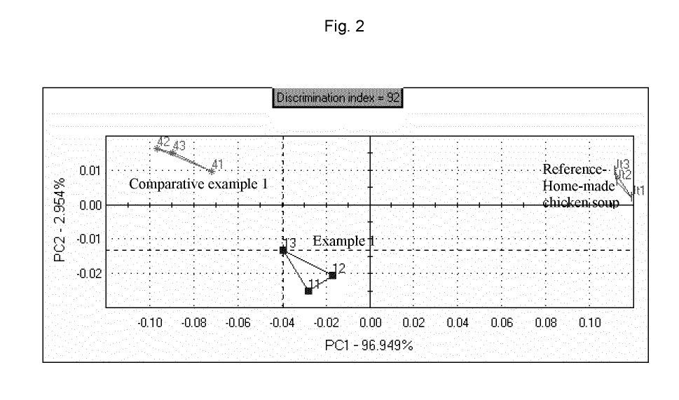

Milled beef paste, salt, dextrose, fresh carrot puree, fresh garlic puree, fresh onion puree and MSG at the same ratios as for Example 2 were mixed, and subjected to granulation and fluidized bed drying for 0.5 min at 105° C. The granules beef flavoured seasoning had a moisture content of 2.5% and size of 2 mm. The product produced according to Example 2 had a more enhanced flavour than the beef seasoning prepared in the conventional manner described in Comparative Example 2. This can be seen from FIG. 2.

### Example 3

### Oyster Sauce

Fresh oyster meat was minced followed by colloid milling. To 9 kg milled oyster paste was added 10 kg water, 5 kg salt and 5 kg sugar and the mixture subjected to a thermal reaction by heating at 95° C. for 50 minutes. A concentrated base/intermediate product was obtained. This concentrated flavour base was mixed with 4 kg starch, 7 kg sugar and 33 kg water, and then pasteurised by heating at 85° C. for 10 min to obtain an oyster sauce.

It was found that oyster sauce produced this way was preferred over ordinary commercial products in a consumer test. Of the 19 consumers in the test, 80% preferred the oyster sauce of Example 3. Reasons for preference and the number of testers who preferred the specific product per each reason are summarized in Table 1.

TABLE 1
Comparison between Example 3 product and conventional product

| | Number of Testers | |
|---|---|---|
| Reason | Conventional product | Example 3 Product |
| More oyster aroma | 1 | 4 |
| Make “cai thia” shining | — | 3 |
| Nicer color | 2 | 3 |
| Better spices aroma | — | 2 |
| Enhanced seafood aroma | — | 2 |
| More oyster flavour | — | 2 |

### Example 4

### Vegetable Instant Soup

A mixture of 1 kg hydrolysate from corn, 0.3 kg mushroom, 0.8 kg water, 0.2 kg cysteine and 1 kg dextrose was prepared and then subjected to a thermal reaction at 100° C. for 60 min to obtain a concentrated base/intermediate product. The product was mixed with 40 kg modified starch and hot air dried at 90° C. for one hour and then at 80° C. for 120 min. The product was milled to a granular product with a particle size of about 1.3 mm. The final product after milling was an instant soup powder with a moisture content of 2.3%.

### Example 5

### Sweet Corn Soup

Frozen sweet corn was minced and then milled to a paste. To this paste was added 1 kg sugar, 0.3 kg proline, 0.7 kg glycine and 0.4 kg dextrose, 0.6 kg fructose to 16 kg corn and the mixture subjected to thermal reaction by heating at 75° C. for 30 minutes. A concentrated base/intermediate product was obtained. The product was mixed with 20 kg modified starch and vacuum dried at 80° C. for 4 hours, followed by milling using a hammer mill to produce a powdered product for use as an instant soup having a moisture content of 3.5%.

It is to be appreciated that although the invention has been described with reference to specific embodiments, variations and modifications may be made without departing from the scope of the invention as defined in the claims. Furthermore, where known equivalents exist to specific features, such equivalents are incorporated as if specifically referred to in this specification.

1. A concentrated flavor base product, comprising a product prepared by carrying out a thermal reaction between a tonality delivering ingredient and at least one thermal reaction precursor.

2. The concentrated flavor base product according to claim 1, wherein the amount of thermal reaction precursor is from 5 to 500 parts by weight based on 100 parts by weight of the tonality delivering ingredient.

3. The concentrated flavor base product according to claim 1, wherein the tonality delivering ingredient is selected from the group consisting of edible meat, aromatic plants, vegetables, and combinations thereof.

4. The concentrated flavor base product according to claim 1, wherein the thermal reaction precursor comprises a compound selected from the group consisting of a carbonyl-containing compound, an amino-containing compound, and combinations thereof.

5. The concentrated flavor base product according to claim 1, wherein the thermal reaction is a Maillard reaction.

6. The concentrated flavor base product according to claim 1, wherein the thermal reaction is carried at 50 to 180° C. for 10 to 360 min.

7. A method for producing a concentrated flavor base product, which comprises thermally reacting a tonality delivering ingredient with at least one thermal reaction precursor.

8. The method according to claim 7, wherein the amount of thermal reaction precursor is from 5 to 500 parts by weight based on 100 parts by weight of the tonality delivering ingredient.

9. The method according to claim 7, wherein the tonality delivering ingredient is selected from the group consisting of edible meat, aromatic plants, vegetables, and combinations thereof.

10. The method according to claim 7, wherein the thermal reaction precursor comprises a component selected from the group consisting of a carbonyl-containing compound, an amino-containing compound, and combinations thereof.

11. The method according to claim 7, wherein the thermal reaction is carried at 50 to 180° C. for 10 to 360 min.

12. The method according to claim 7, comprising milling the tonality delivering ingredient into a paste or a powder before the thermal reaction step.

13. The method according to claim 12, wherein the milling is colloid milling.

14. A method for preparing a culinary flavoring product from ingredients including a tonality delivering ingredient and other ingredients, comprising the steps of:
reacting the tonality delivering ingredient with at least one thermal reaction precursor to obtain an intermediate product; and
processing the intermediate product with the other ingredients to obtain the final culinary flavoring product.

15. The method according to claim 14, wherein the processing step comprises a step selected from the group consisting of granulation, drying, pasteurisation, and combinations thereof.

16. The method according to claim 14, wherein the other ingredients are selected from the group consisting of starch, MSG, salt, and water, and combinations thereof.

17. The method according to claim 14, comprising milling the tonality delivering ingredient into paste or powder.

18. A culinary flavoring product prepared by method of claim 14.

19. The culinary flavoring product of claim 14, in a form selected from the group consisting of liquid, paste, powder and granules.
